(19) United States
(12) Patent Application Publication
(10) Pub. No.: US 2026/0260327 A1
(43) Pub. Date: Sep. 3, 2026

(54) CONTINUOUSLY IMPROVING PERCEPTUAL QUALITY VIDEO MEASUREMENT WITH PROJECTED GRADIENT DESCENT

(71) Applicant: IMAX CORPORATION, Mississauga, Ontario (CA)

(72) Inventors: Zhengfang DUANMU, Maple, Ontario (CA); Wentao LIU, Maple, Ontario (CA); Mingzhe JIANG, Waterloo, Ontario (CA)

(73) Assignee: IMAX CORPORATION, Mississauga, Ontario (CA)

(21) Appl. No.: 19/474,325

(22) PCT Filed: Apr. 12, 2024
(86) PCT No.: PCT/IB2024/053635

§ 371 Date: Oct. 10, 2025

Related U.S. Application Data
(60) Provisional application No. 63/496,066, filed on Apr. 14, 2023.

(51) Int. Cl. G06T 7/00; G06V 10/46; G06V 10/82

(52) U.S. Cl. CPC G06T 7/0002; G06V 10/462; G06V 10/82; G06T 2207/10016; G06T 2207/20081; G06T 2207/20084; G06T 2207/30168

(57) ABSTRACT

A method for predicting video distortion as perceived by an observer includes obtaining a pair of video signals including a reference video and a distorted video signal of the reference video, defining a perceptual transformation model that decomposes the pair of video signals into multiple channel representations, generating saliency maps based on the output of the perceptual transformation model employing a discontinuous approximation model that has a multi-layer CNN interleaved with a series of sigmoid functions, generating quality maps of the output of the perceptual transformation model based on a structural similarity model employing a set of learned parameters, and determining a video quality value based on the saliency maps and the quality maps. The learned parameters include a learned stabilization constant and a learned weighting factor, and the learned parameters are based on a set of initial parameters and a projected gradient descent algorithm.

### CROSS-REFERENCE TO RELATED APPLICATIONS

This application claims the benefit of U.S. provisional application Ser. No. 63/496,066 filed Apr. 14, 2023, the disclosure of which is hereby incorporated in its entirety by reference herein.

### TECHNICAL FIELD

Aspects of the disclosure generally relate to a method and/or system for using machine learning approaches to improve objective video quality assessment of video.

### BACKGROUND

The statements in this section merely provide background information related to the present disclosure and may not constitute prior art.

Objective video quality assessment (VQA) methods predict a perceptual quality of a video targeted at reproducing or at best approximating human visual subjective quality assessment of the video. One such VQA is SSIMPLUS, which is an objective full-reference VQA measure that can automatically predict the quality assessment behaviors of humans viewing a video signal based on undistorted reference video of the video signal being viewed. As known, “SSIM” stand for structural similarity index measure. Over the past decade, SSIMPLUS has become one of the industry standards for video quality measurements partially impart to efficiency and device adaptive quality assessment capability.

### SUMMARY

In one form, the present disclosure is directed to a method for training a predicting video distortion as perceived by an observer. The method includes: obtaining a pair of video signals including a reference video signal and a distorted video signal of the reference video signal; defining a perceptual transformation model that decomposes the pair of video signals into multiple channel representations; generating a set of saliency maps based on an output of the perceptual transformation model employing a discontinuous approximation model that has a multi-layer convolutional neural network (CNN) interleaved with a series of sigmoid functions; and generating a set of quality maps of the output of the perceptual transformation model based on a structural similarity model employing a set of learned parameters. The learned parameters include a learned stabilization constant and a learned weighting factor, and the learned parameters are based on a set of initial parameters and a projected gradient descent algorithm. The method further includes determining a video quality value based on the set of saliency maps and the set of quality maps.

In one form, the present disclosure is directed to a system for predicting video distortion as perceived by an observer of a pair of video signals including a reference video and a distorted video signal of the reference video. The system includes one or more computing devices configured to: define a perceptual transformation model that decomposes the pair of video signals into multiple channel representations; generate a set of saliency maps based on an output of the perceptual transformation model employing a discontinuous approximation model that has a multi-layer convolutional neural network (CNN) interleaved with a series of sigmoid functions; generate a set of quality maps of the output of the perceptual transformation model based on a structural similarity model employing a set of learned parameters; and determine a video quality value based on the set of saliency maps and the set of quality maps. The learned parameters include a learned stabilization constant and a learned weighting factor, and the learned parameters are based on a set of initial parameters and a projected gradient descent algorithm.

### BRIEF DESCRIPTION OF THE DRAWINGS

In order that the disclosure may be well understood, there will now be described various forms thereof, given by way of example, reference being made to the accompanying drawings, in which:

FIG. 1 is block diagram of a full-reference (FR) video quality assessment (FR VQA) system in accordance with the present disclosure;

FIG. 2 is a block diagram of a quality analyzer module of the FR VQA system of FIG. 1;

FIG. 3 is a block diagram of a saliency module of the FR VQA system of FIG. 1; and

FIG. 4 is a block diagram of a quality score and display normalization of the FR VQA system of FIG. 1.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

Despite the demonstrated success, improving or enhancing knowledge-driven models can be inconvenient, time-consuming, and expensive. At the same time, machine learning models can process data at scales far beyond human capabilities revolutionizing many technological areas. In a non-limiting example, advancements in the area of computer vision employed deep neural networks which is believed to result in systems having superhuman capabilities on visual recognition, object detection, and semantic segmentation tasks.

A machine learning model, such as a deep learning network, may be trained using a known VQA model. This may be done in an attempt to build a machine learning model that operates consistent to the operation of the VQA model. However, adaptations may be needed in the VQA model or the learning algorithm to facilitate such training, and the mathematical tractability of the VQA may be difficult to preserve during the learning process.

To implement such an approach, the objective VQA may be formulated as a Bayesian inference problem, where learning algorithms and model architectures represent the likelihood and weight initialization represents the prior terms. The VQA may thus be interpreted as a deep neural network with a fixed set of model weights, such that it is possible to automatically improve its performance from data with an appropriate learning algorithm. The VQA may also include convolution, addition, multiplication, division, and thresholding operators at multiple scales. Such a structure may be similar to the deep learning model U-Net, which is a convolutional neural network that was developed for biomedical image segmentation. Generally, U-Net is based on a fully convolutional network that works with fewer training images and yields more precise segmentation.

Although such a Bayesian framework may unify the VQA with a deep neural network, certain VQAs, such as the SSIMPLUS framework, depend on several discontinuous computational modules. Such computations may be difficult to optimize with gradient-based optimization algorithms. In addition, SSIMPLUS may have mathematical regularity such as convexity, boundedness, and monotonicity in certain computational modules, which may be difficult to govern by traditional deep learning algorithms. Furthermore, some building blocks of SSIMPLUS may be translational and scaling invariant, which can make the learning process unstable and difficult to converge. An example of the SSIMPLUS architecture is provided in U.S. Pat. No. 10,165,281 titled: METHOD AND SYSTEM FOR OBJECTIVE PERCEPTUAL VIDEO QUALITY ASSESSMENT, which is assigned to the applicant of the present disclosure and the disclosure of which is incorporated herein as reference.

As described in detail herein, the present disclosure is generally directed to a FR VQA employing SSIMPLUS-neural network architecture that continuously learns from, for example, millions of videos without human intervention, while preserving some useful mathematical properties generally associated with SSIMPLUS. More particularly, the FRVQA of the present disclosure: (1) defines a SSIMPLUS as a neural network (f_{θ}) and initializes model weights as described by an original SSIMPLUS; (2) predicts the video quality ŷᵢ=f_{θ}(xᵢ) for each pair of videos and its perceptual quality label (xᵢ, yᵢ) in in a dataset set {(xᵢ, yᵢ)}ᵢ₌₁^{N} of size N; (3) measures the performance of the current model with a differentiable evaluation criterion on the dataset; (4) adjust the model parameter θ with an optimization algorithm such that the updated model; and (5) repeats (2)-(4) until convergence. As described herein, the proposed FR VQA accurately predicts subjective quality scores, as evident by the state-of-the-art performance on twelve publicly available VQA datasets.

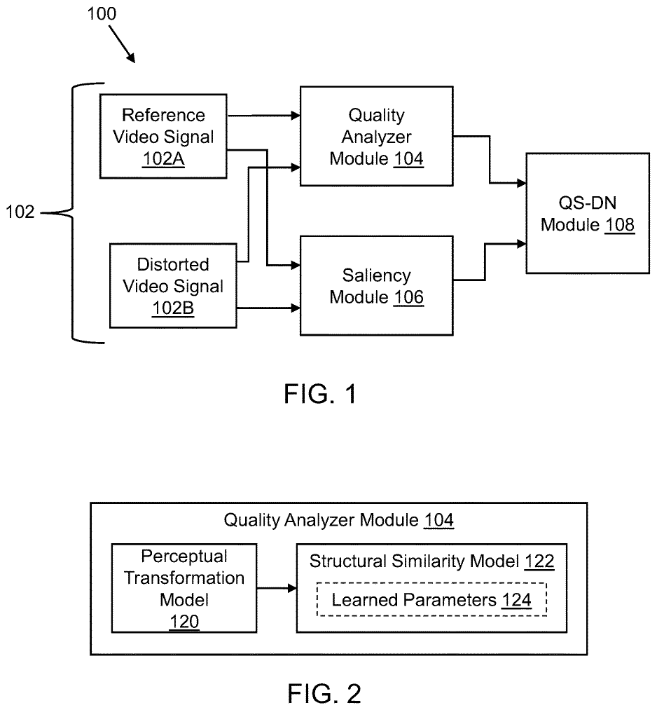

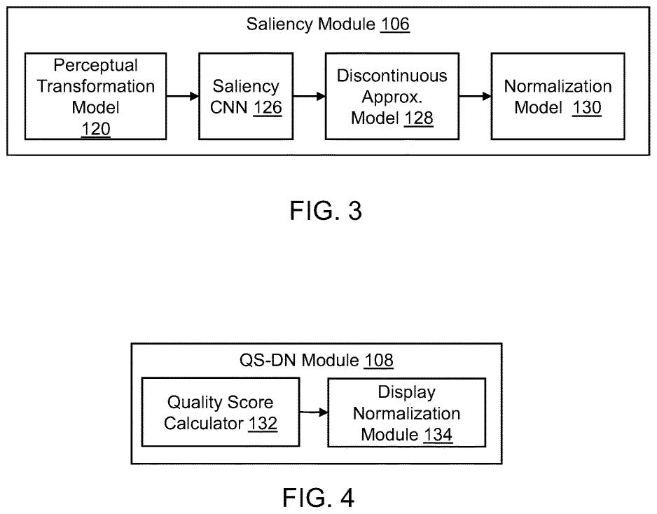

Referring to FIG. 1, a FR VQA system 100 of the present disclosure employs SSSIMPLUS-neural network architecture to analyze a pair of video signals 102 including a reference video signal 102A and a distorted video signal 102B. The FR VQA system 100 is configured to include three sub-systems: a quality analyzer module 104, a saliency module 106, and a quality score and display normalization (QS-DN) module 108. In one form, each of the quality analyzer module 104, the saliency module 106, and a QS-DN module 108 define linear and non-linear layers. Further aspects of the quality analyzer module 104 are discussed with respect to FIG. 2. Further aspects of the saliency module 106 are discussed with respect to FIG. 3. Further aspects of the QS-DN module 108 are discussed with respect to FIG. 4.

Referring to FIG. 2, in one form, the quality analyzer module 104 is configured to generate a set of quality maps, and at least includes a perceptual transformation model 120 and a structural similarity model 122 employing learned parameters 124 defined by gradient descent.

The perceptual transformation model 120 is configured to perform a perceptual-driven transformation to decompose a video frame into multiple scales, where each scale is associated with a different spatial frequency range. In one form, the perceptual transformation model 120 employs a variant of U-Net and appends a batch normalization layer to each convolutional operator.

The structural similarity model 122 is configured to compute or generate the quality maps of each scale based on a structure comparison between subsequent reference and distorted scales. Specifically, the quality analyzer module 104 evaluates a local video quality using a variant of a structural similarity measure and the learned parameters 124. Accordingly, the quality analyzer is configured to generate the set of quality maps of the decomposed video frames outputted by the perceptual transformation model 120 based on the structural similarity model 122 employing a set of learned parameters 124. The learned parameters 124 include a learned stabilization constant and a learned weighting factor.

For the learned parameters 124, a projected gradient descent methodology is employed as the learning scheme, which iterates between a gradient descent step and a parameter projection process. Specifically, the learned parameters 124 are based on a set of initial parameters and a projected gradient descent algorithm. In one form, the set of learned parameters 124 are determined by: sampling a frame from an initial video datasets; generating an initial video quality value of the sampled frames based on the set of initial parameters; evaluating the initial video quality value based on a differentiable evaluation model to determine whether the initial video quality value satisfies a desired condition, and adjusting values of the set of parameters to obtain the learned parameters 124 based on a parameter optimization algorithm in response to the initial video quality value not being satisfied, where the parameter optimization algorithm employs projected gradient descent to obtain the learned parameters 124.

The set of initial parameters include a stabilization constant and a weighted factor that are set to an initial value, which can be selected using original methodology of SSIMPLUS, such as but not limited to, prior knowledge about human vision system or small-scale experiment on limited data, which may not generalize well in practical application scenarios.

Referring to FIG. 3, the saliency module 106 is configured to generate a set of saliency maps and, in one form, at least includes the perceptual transformation model 120, a saliency CNN, a discontinuous approximation model 128, and a normalization model 130.

The perceptual transformation model 120 is the same as that used in the quality analyzer module 104, and thus, the description is omitted for purposes of brevity.

The saliency CNN 126 is configured to apply an information content weighting function to the decomposed video frames to generate a set of initial saliency maps. In one form, the saliency CNN 126 is defined as a multi-layer convolutional neural network configured to reproduce non-linear operators and enable gradient-based optimization.

The discontinuous approximation model 128 is defined as a series of sigmoid functions to approximate discontinuous thresholding functions of the set of initial saliency maps, which may improve the differentiability of the saliency module 106.

The normalization model 130 is configured to bound and spatially normalize the initial saliency maps to generate the set of saliency maps.

Referring to FIG. 4, the QS-DN module 108 is configured to determine an overall video quality of the distorted video signal, and in one form, at least includes a quality score calculator 132 and a display normalization module 134.

The quality score calculator 132 is configured to calculate a quality score for each scale employing a weighted combination of the set of quality maps and the set of saliency maps, which are scale-wise maps.

The display normalization module 134 is configured to determine a video quality based on the quality scores. More particularly, the display normalization module 134 is configured weight the quality scores at different scales based on various factors including, but not limited to: a sampling density of the pair of video signals, one or more viewing conditions, a display device, and a perceptual capability of a visual system of an observer. In one form, the display normalization module 134 is configured to compute an overall video quality as a convex combination of the quality scores at different frequency bands, where the weight is determined from a contrast sensitivity function, which describes how sensitivity to narrow-band stimuli varies with spatial and/or temporal frequency.

In one form, while the present disclosure describes the structural similarity model 122 as having parameters that are learned, other features of the FR-VQA system 100 may employ machine learning methodologies, including variants of gradient descent, for respective parameters.

In a non-limiting example, the display normalization module 134 is configured to include learnable parameters. Specifically, the display normalization module 134 includes a pooling module, where the parameters of the pooling module are optimized by a variant of gradient descent algorithm. That is, the display normalization module 134 defines a series of linear and non-linear layers. Parameters of the linear layers are learned, where in y=mx+b, x would be the quality scores across the different frequency sub-bands and m and b would be learnable. After each gradient step, the weights across different frequency bands are re-normalized to conform the convex constraint.

Experimental results may be used to illustrate the performance of a FR VQA system having the SSIMPLUS-neural network architecture of the present disclosure. For the experiments, a neural network architecture was trained on an internal subject-rated dataset that contained hundreds of pristine video contents that were contaminated by a wide variety of distortion types and levels. The training data was also augmented by randomly horizontally flipping the pair of video signals 102A-B. A Pearson linear correlation coefficient (PLCC) was used as the loss function because 1) it is one of the widely accepted performance evaluation criteria for objective VQA models, and 2) it is differentiable. The training process adopts the Adam optimization algorithm with a mini batch of 32. The learning rate was originally set to 10⁻² and subsequently lowered by a factor of 10 when the loss plateaus, until the learning rate reached 10⁻⁴.

One of the goals of objective VQA models is to predict subjective quality evaluation of a video. To this end, the FR VQA system may be evaluated using twelve standard subject-rated VQA datasets, including: (1) AVT-VQDB-UHD1; (2) AVT-VQDB-UHD23; (3) BVICC-HD; (4) BVICC-UHD; (5) BVIHD; (6) CSIQ; (7) LIVE; (8) MCLV; (9) IVP; (10) SCVD; (11) NFLX-Public; and (12) and Waterloo4K. The performance of the FR VQA system having the SSSIMPLUS-neural network architecture of the present disclosure may also be compared to the other widely used VQA measures, including: (1) Peak Signal-to-Noise Ratio (PSNR); (2) Structural Similarity (SSIM); (3) Multi-Scale Structural Similarity (MS-SSIM); (4) original SSIMPLUS; and Video Multimethod Assessment Fusion (VMAF). PLCC, Spearman's rank correlation coefficient (SRCC), and mean absolute error (MAE) may be used to assess the performance of VQA measures. Among the above metrics, PLCC and MAE are adopted to evaluate prediction accuracy, and SRCC is employed to assess prediction monotonicity.

The performance comparison results are shown in Tables 1, 2, and 3 provided below. First, it can be seen that the proposed model achieved state-of the art performance on all test datasets. Although there is slight performance bias towards 4K content, the machine-learning version of the SSIMPLUS model aligns all content/distortions pretty well across the perceptual space. Second, it can be seen that the data-driven SSIMPLUS consistently delivered a more accurate prediction than the knowledge-driven counterpart on all test datasets and with all evaluation criteria. Specifically, the improvement was as large as 27.7%, 21.20%, and 24.85% on individual test set in terms of PLCC, SRCC, and MAE, respectively. The experiment appeared to demonstrate strong promise in the new design paradigm which combined the prior knowledge and the data-driven method in a principled way. Third, it can be seen that the proposed method outperformed other learning-based VQA model VMAF, whose feature extraction procedure is hand-crafted, which is believed to be partially attributed to the jointly end-to-end optimization scheme.

TABLE 1
Performance of Objective VQA models in Terms of PLCC

| | | | MS- | | | |
|---|---|---|---|---|---|---|
| | PSNR | SSIM | SSIM | VMAF | SSIMPlus | Proposed |
| AVT-VQDB- | 0.826 | 0.807 | 0.811 | 0.956 | 0.923 | 0.956 |
| UHD1 | | | | | | |
| AVT-VQDB- | 0.731 | 0.811 | 0.720 | 0.871 | 0.733 | 0.936 |
| UHD23 | | | | | | |
| BVICC-HD | 0.623 | 0.722 | 0.720 | 0.829 | 0.736 | 0.783 |
| BVICC-UHD | 0.608 | 0.700 | 0.720 | 0.809 | 0.687 | 0.809 |
| BVIHD | 0.558 | 0.734 | 0.750 | 0.783 | 0.800 | 0.824 |
| CSIQ | 0.567 | 0.686 | 0.749 | 0.624 | 0.777 | 0.823 |
| LIVE | 0.484 | 0.683 | 0.745 | 0.759 | 0.693 | 0.779 |
| MCLV | 0.466 | 0.648 | 0.656 | 0.778 | 0.662 | 0.862 |
| IVP | 0.821 | 0.763 | 0.836 | 0.897 | 0.883 | 0.927 |
| SCVD | 0.650 | 0.703 | 0.750 | 0.672 | 0.857 | 0.865 |
| NFLX-Public | 0.670 | 0.732 | 0.752 | 0.935 | 0.803 | 0.967 |
| Waterloo4K | 0.472 | 0.581 | 0.581 | 0.762 | 0.832 | 0.880 |
| Average | 0.623 | 0.714 | 0.733 | 0.806 | 0.782 | 0.868 |

TABLE 2
Performance of Objective VQA models in Terms of SRCC

| | | | MS- | | | |
|---|---|---|---|---|---|---|
| | PSNR | SSIM | SSIM | VMAF | SSIMPlus | Proposed |
| AVT-VQDB- | 0.844 | 0.863 | 0.868 | 0.951 | 0.934 | 0.955 |
| UHD1 | | | | | | |
| AVT-VQDB- | 0.747 | 0.860 | 0.796 | 0.871 | 0.786 | 0.952 |
| UHD23 | | | | | | |
| BVICC-HD | 0.603 | 0.751 | 0.752 | 0.869 | 0.741 | 0.756 |
| BVICC-UHD | 0.552 | 0.694 | 0.730 | 0.836 | 0.693 | 0.816 |
| BVIHD | 0.553 | 0.733 | 0.745 | 0.770 | 0.791 | 0.810 |
| CSIQ | 0.580 | 0.656 | 0.747 | 0.615 | 0.775 | 0.841 |
| LIVE | 0.456 | 0.671 | 0.738 | 0.751 | 0.687 | 0.768 |
| MCLV | 0.476 | 0.633 | 0.644 | 0.777 | 0.655 | 0.859 |
| IVP | 0.820 | 0.740 | 0.817 | 0.879 | 0.882 | 0.918 |
| SCVD | 0.649 | 0.712 | 0.758 | 0.655 | 0.858 | 0.858 |
| NFLX-Public | 0.640 | 0.713 | 0.740 | 0.909 | 0.821 | 0.951 |
| Waterloo4K | 0.462 | 0.555 | 0.537 | 0.763 | 0.827 | 0.877 |
| Average | 0.615 | 0.715 | 0.739 | 0.804 | 0.788 | 0.863 |

TABLE 3
Performance of Objective VQA models in Terms of MAE.

| | | | MS- | | | |
|---|---|---|---|---|---|---|
| | PSNR | SSIM | SSIM | VMAF | SSIMPlus | Proposed |
| AVT-VQDB- | 11.016 | 11.540 | 10.807 | 6.103 | 7.841 | 6.088 |
| UHD1 | | | | | | |
| AVT-VQDB- | 14.162 | 12.283 | 14.882 | 10.924 | 14.065 | 7.475 |
| UHD23 | | | | | | |
| BVICC-HD | 9.059 | 7.624 | 7.692 | 5.945 | 7.475 | 6.894 |
| BVICC-UHD | 6.486 | 5.447 | 5.253 | 4.617 | 5.633 | 4.561 |
| BVIHD | 11.322 | 8.650 | 8.467 | 8.124 | 7.906 | 7.409 |
| CSIQ | 10.905 | 9.510 | 8.615 | 10.425 | 7.985 | 7.392 |
| LIVE | 7.891 | 6.513 | 5.844 | 5.806 | 6.462 | 5.666 |
| MCLV | 20.868 | 17.527 | 17.248 | 14.227 | 17.284 | 11.746 |
| IVP | 10.565 | 11.726 | 10.338 | 8.906 | 8.996 | 7.031 |
| SCVD | 8.356 | 7.751 | 7.192 | 8.135 | 5.475 | 5.402 |
| NFLX-Public | 16.270 | 14.113 | 13.607 | 7.227 | 12.008 | 5.314 |
| Waterloo4K | 17.270 | 15.698 | 15.737 | 12.242 | 10.253 | 8.719 |
| Average | 12.014 | 10.699 | 10.474 | 8.557 | 9.282 | 6.975 |

In this application, the term “module” may refer to, be part of, or include: an application specific integrated circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method for training a predicting video distortion as perceived by an observer, the method comprising:
obtaining a pair of video signals including a reference video signal and a distorted video signal of the reference video signal;
defining a perceptual transformation model that decomposes the pair of video signals into multiple channel representations;
generating a set of saliency maps based on an output of the perceptual transformation model employing a discontinuous approximation model that has a multi-layer convolutional neural network (CNN) interleaved with a series of sigmoid functions;
generating a set of quality maps of the output of the perceptual transformation model based on a structural similarity model employing a set of learned parameters, the learned parameters including a learned stabilization constant and a learned weighting factor, wherein the learned parameters are based on a set of initial parameters and a projected gradient descent algorithm; and
determining a video quality value based on the set of saliency maps and the set of quality maps.

2. The method of claim 1, further comprising determining the set of learned parameters.

3. The method of claim 2, wherein the determining the set of learned parameters further includes:
sampling frames from initial video datasets;
generating an initial video quality value of the sampled frames based on the set of initial parameters, wherein the set of initial parameters include an initial stabilization constant and an initial weighted factor;
evaluating the initial video quality value based on a differentiable evaluation model to determine whether the initial video quality value satisfies a desired condition; and
adjusting values of the set of parameters to obtain the learned parameters based on a parameter optimization algorithm in response to the initial video quality value not being satisfied.

4. The method of claim 3, wherein the parameter optimization algorithm employs projected gradient descent to obtain the learned parameters.

5. The method of claim 1, wherein the perceptual transformation model is a U-Net based convolution network.

6. The method of claim 1 further comprising spatially normalizing the set of saliency maps.

7. A system for predicting video distortion as perceived by an observer of a pair of video signals including a reference video and a distorted video signal of the reference video, the system comprising:
one or more computing devices configured to:
define a perceptual transformation model that decomposes the pair of video signals into multiple channel representations;
generate a set of saliency maps based on an output of the perceptual transformation model employing a discontinuous approximation model that has a multi-layer convolutional neural network (CNN) interleaved with a series of sigmoid functions;
generate a set of quality maps of the output of the perceptual transformation model based on a structural similarity model employing a set of learned parameters, the learned parameters including a learned stabilization constant and a learned weighting factor, wherein the learned parameters are based on a set of initial parameters and a projected gradient descent algorithm; and
determine a video quality value based on the set of saliency maps and the set of quality maps.

8. The system of claim 7, wherein the one or more computing devices is further configured to determine the set of learned parameters.

9. The system of claim 8, wherein to determine the set of learned parameter, the one or more computing devices is further configured to:
sample frames from initial video datasets;
generate an initial video quality value of the sampled frames based on the set of initial parameters, wherein the set of initial parameters include an initial stabilization constant and an initial weighted factor;
evaluate the initial video quality value based on a differentiable evaluation model to determine whether the initial video quality value satisfies a desired condition; and
adjust values of the set of parameters to obtain the learned parameters based on a parameter optimization algorithm in response to the initial video quality value not being satisfied.

10. The system of claim 9, wherein the parameter optimization algorithm employs projected gradient descent to obtain the learned parameters.

11. The system of claim 7, wherein the perceptual transformation model is a U-Net based convolution network.

12. The system of claim 7, wherein the one or more the one or more computing devices is further configured to spatially normalize the set of saliency maps.
